(19) United States
(12) Patent Application Publication
(10) Pub. No.: US 2016/0172867 A1
(43) Pub. Date: Jun. 16, 2016

(54) CONTROL OF POWER TRANSFER

(71) Applicants: STANISLAV ARENDARIK, BANSKÁ BYSTRICA (SK); VACLAV HALBICH, IVANCICE (CZ)

(72) Inventors: STANISLAV ARENDARIK, BANSKÁ BYSTRICA (SK); VACLAV HALBICH, IVANCICE (CZ)

(73) Assignee: FREESCALE SEMICONDUCTOR, INC., Austin, TX (US)

(21) Appl. No.: 14/568,250

(22) Filed: Dec. 12, 2014

(51) Int. Cl. H02J 5/00; H02J 17/00

(52) U.S. Cl. CPC H02J 5/005; H02J 17/00

(57) ABSTRACT

An apparatus comprising: a first transmitter configured to transmit in a first channel defined by a first frequency band; a second transmitter configured to transmit in a second channel defined by a second frequency band; and a controller configured to control power transfer via the first channel in dependence upon an impedance of the first channel and an impedance of the second channel.

### FIELD OF THE INVENTION

This invention relates to control of power transfer. In particular, some examples relate to control of power transfer by a contactless charger.

### BACKGROUND OF THE INVENTION

Contactless charging uses a non-radiative electromagnetic near field created by a charging device to transfer energy to a charged device.

For example, a coiled antenna in the charging device and a coiled antenna in the charged device can form a transformer and energy is transferred by inductive coupling.

As another example, a resonant coiled antenna in the charging device and a resonant coiled antenna in the charged device form a resonant transformer and energy is transferred by inductive coupling at the common resonant frequency of the resonant coiled antennas.

A problem that can arise is the presence of a foreign object in a charging area of a charging device. Such a foreign object may absorb the electro-magnetic energy generated by the charging device, and it may be heated creating a safety concern.

It would be desirable to control power transfer from the charging device so that it occurs only when a charged device is present and does not occur when a foreign object is present.

Previous approaches to this problem have been to create a closed feedback loop from the charging device to the charged device and back to the charging device. This requires that the charged device can communicate with the charging device. The requirements of the closed feedback loop including for example the requirement for communication from the charged device to the charging device increase costs.

### SUMMARY OF THE INVENTION

The present invention provides an apparatus, a method, and a computer program as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale.

FIG. 1 shows an example of an embodiment of an apparatus;

FIG. 2 schematically shows an example of an embodiment in which the first signal is transmitted by the first transmitter into a first channel that has a first impedance Z₁ and the second signal is transmitted by the second transmitter into a second channel that has a second impedance Z₂;

FIG. 3 shows schematically an example of an embodiment of a method;

FIG. 4 shows schematically an example of an embodiment where the controller controls the first transmitter to perform power transfer in the first channel to a receiver device;

FIG. 5 shows schematically an example of an embodiment where a first signal and a second signal are transmitted sequentially;

FIG. 6 shows schematically an example of an embodiment of a method using sequential first and second signals; and

FIG. 7 shows schematically an example of an embodiment of a method which may be used when the first signal and the second signal are transmitted sequentially or in parallel.

### DETAILED DESCRIPTION OF THE PREFERRED EMBODIMENTS

Because the illustrated embodiments of the present invention may, for the most part, be implemented using electronic components and circuits known to those skilled in the art, details will not be explained in any greater extent than that considered necessary for the understanding and appreciation of the underlying concepts of the present invention and in order not to obfuscate or distract from the teachings of the present invention.

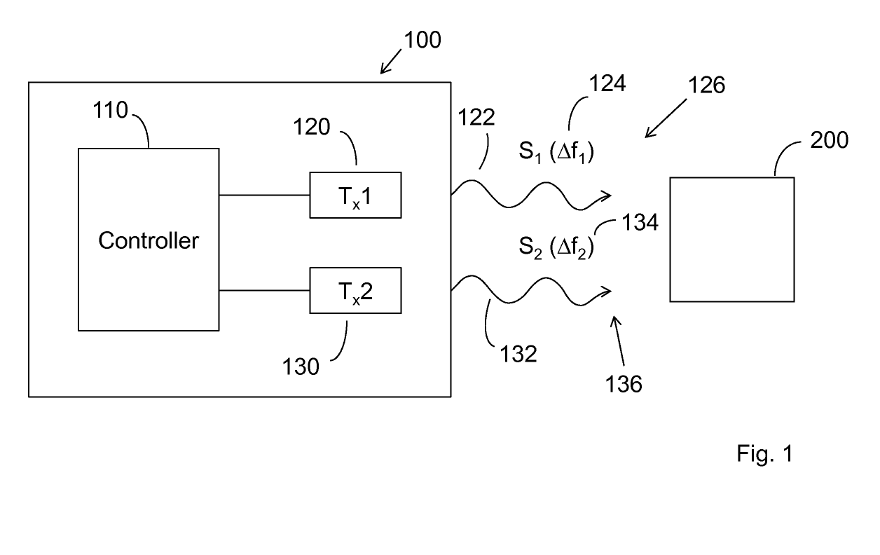

FIG. 1 shows an example of an embodiment of an apparatus 100. The apparatus 100 may, for example, be a contactless charging apparatus that is configured to transfer power via electromagnetic energy to a receiver device. Such a receiver device would be in the position of the object 200 in FIG. 1. However, it is possible for objects 200 other than receiver devices to be located in the charging area of the apparatus 100. In some cases, where such an object 200 is a metallic object or other object that absorbs electromagnetic energy, that object 200 may absorb electromagnetic energy transmitted by the apparatus 100 and be heated. This is not only a waste of energy but also potentially a hazard.

It would therefore be desirable to have the apparatus 100 configured so that it automatically transfers power to a suitable receiver device 202 but does not transfer electromagnetic energy to an unsuitable foreign object 200.

The apparatus 100 in this example comprises a first transmitter 120, a second transmitter 130 and a controller 110.

In this example, the first transmitter 120 and the second transmitter 130 are illustrated as separate components. This is merely for ease of explanation and illustration. It is possible for the first transmitter 120 and the second transmitter 130 to comprise separate transmission circuitry and separate antennas but it is also possible for the first transmitter 120 and the second transmitter 130 to share common transmitter circuitry and/or a common antenna.

The controller 110 is configured to be in communication with the first transmitter 120 and the second transmitter 130.

The first transmitter 120 is configured to transmit a first signal S₁ 122 in a first channel 126. The first channel 126 is defined by a first frequency band 124. The first frequency band 124 is a contiguous range of frequencies Δf₁.

The second transmitter 130 is configured to transmit a second signal S₂ 132 in a second channel 136. The second channel 136 is defined by a second frequency band 134. The second frequency band 134 is a contiguous range of frequencies Δf₁.

The first channel and the second channel are different channels and the first frequency band and the second frequency band 124, 134 are different frequency bands. In some, but not necessarily all embodiments the first channel 126 and the second channel 136 are distinct and separate channels and the first frequency band 124 and the second frequency band 134 do not overlap. For example, the first frequency band 124 may in some, but not necessarily all, examples be a frequency band that is less than 1 kHz and in some but not necessarily all examples the second frequency band 134 may be a frequency band that is greater than 100 kHz. In one particular example, the first frequency band 124 may be at 110 kHz and the second frequency band 134 may be at 500 kHz.

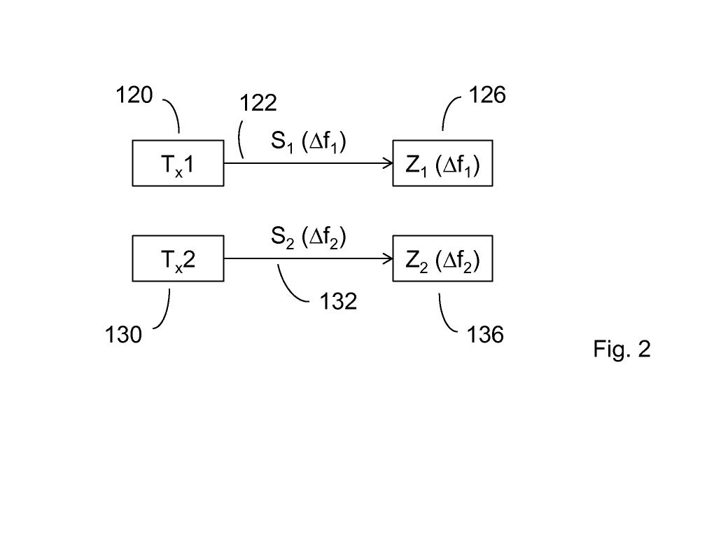

FIG. 2 schematically shows an example of an embodiment in which the first signal S₁ 122 is transmitted by the first transmitter 120 into the first channel 126 that has a first impedance Z₁. The first signal is sent within the first frequency band 124 and the first impedance Z₁ relates to the impedance of the first channel 126 at the first frequency band 124.

Likewise FIG. 2 schematically shows an example of an embodiment in which the second transmitter 130 transmits the second signal S₂ 132 into the second channel 136 which has a second impedance Z₂.

It will be appreciated that as the first impedance Z₁ for the first channel 126 varies the power absorbed by the first channel 126 changes and the power supplied by the first transmitter 120 changes. The first transmitter 120 is therefore capable of making or enabling a first measurement M[Z₁] that is dependent upon the first impedance Z₁ of the first channel 126, for example.

It will be appreciated that as the second impedance Z₂ for the second channel 136 varies the power absorbed by the second channel 136 changes and the power supplied by the second transmitter 130 changes. The second transmitter 130 is therefore capable of making or enabling a second measurement M[Z₁] that is dependent upon the second impedance Z₂ of the second channel 136, for example.

When a receiver device 202 is located adjacent the apparatus 100 in a charging area, then the first impedance Z₁ for the first channel 126 is low enabling the easy transfer of power from the apparatus 100 to the device 202. However, the second impedance Z₂ of the second channel 136 is high. The apparatus 100 is therefore able to use the first transmitter 120 to send a first signal 122 and obtain a first measurement M[Z₁] dependent upon the first impedance Z₁ of the first channel 126 and to use the second transmitter 130 to send a second signal 132 and obtain a second measurement M[Z₁] dependent upon the second impedance Z₂ of the second channel 136. A significant difference between the first impedance Z₁ and the second impedance Z₂ is an indication that a receiver device 202 is adjacent the apparatus 100. It is therefore possible for the apparatus 100 to safely transfer power to the receiver device 202 via the first channel 126.

When a foreign object is adjacent the apparatus 100 in the charging area, the first impedance Z₁ of the first channel is low and the second impedance Z₂ of the second channel 136 is low. It is therefore possible for the apparatus 100 to use the first transmitter 120 to send a first signal 122 and obtain a first measurement M[Z₁]dependent upon the first impedance Z₁ of the first channel 126 and to use the second transmitter 130 to send a second signal 132 and obtain a second measurement M[Z₁] dependent upon the second impedance Z₂ of the second channel 136 to determine the presence of a foreign object 200. A insignificant difference between the first impedance Z₁ and the second impedance Z₂ (both being low) may be an indication that a foreign object 200 is adjacent the apparatus 100. In this case the apparatus 100 will not transfer power to the foreign object 200.

In the absence of any object in the charging area adjacent the apparatus 100, the first impedance Z₁ of the first channel 126 and the second impedance Z₂ of the second channel 136 are both high and no power transfer occurs.

The apparatus 100 is therefore able, by using two different channels 126, 136, to disambiguate an object that absorbs energy in the first channel 126 by determining whether or not that object also absorbs energy in the second channel 136. If the object absorbs energy in the second channel 136 it is a foreign object 200 and if it does not absorb energy in the second channel 136 it is a receiver device 202 to which power may be transferred via the first channel 126.

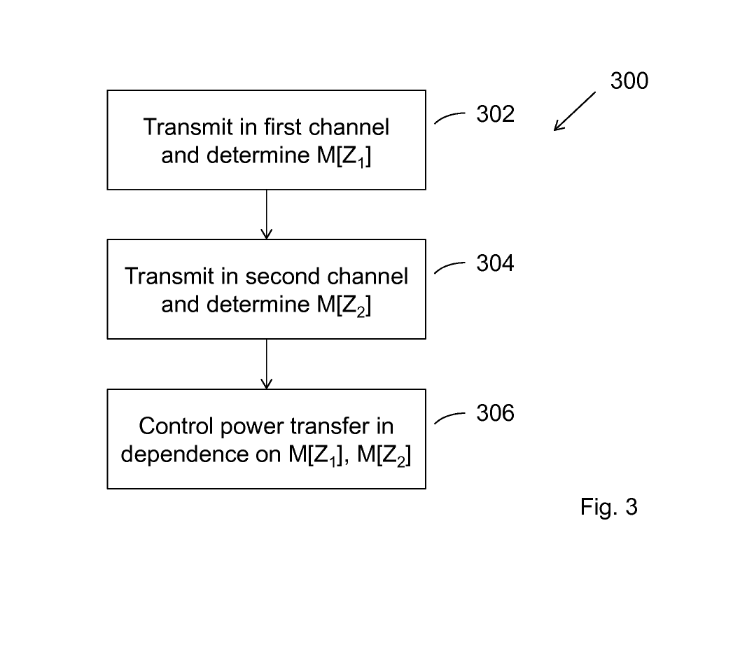

FIG. 3 shows schematically an example of an embodiment of a method 300. At block 302, a transmission in the first channel 126 is used to determine a first measurement M[Z₁] dependent upon the first impedance Z₁ of the first channel 126.

At block 304, a transmission in the second channel 136 is used to determine a second measurement M[Z₂] dependent upon the second impedance Z₂ of the second channel 136.

At block 306, the controller 110 controls power transfer in dependence upon the first measurement M[Z₁] dependent upon the first impedance Z₁ of the first channel 126 and the second measurement M[Z₂] dependent upon the second impedance Z₂ of the second channel 136.

It will be appreciated that the determination of the first measurement M[Z₁] dependent upon the impedance of the first channel 126 may be performed at the first transmitter 120 or at the controller 110. Likewise it will be appreciated that the determination of the second measurement M[Z₂] dependent upon the second impedance Z₂ of the second channel 136 may be performed at the second transmitter 130 or at the controller 110.

The analysis of the first measurement M[Z₁] dependent upon the first impedance Z₁ and the second measurement M[Z₂] dependent upon the second impedance Z₂ is performed at the controller 110. The controller 110 is then configured to control the first transmitter 120 to either enable or disable power transfer.

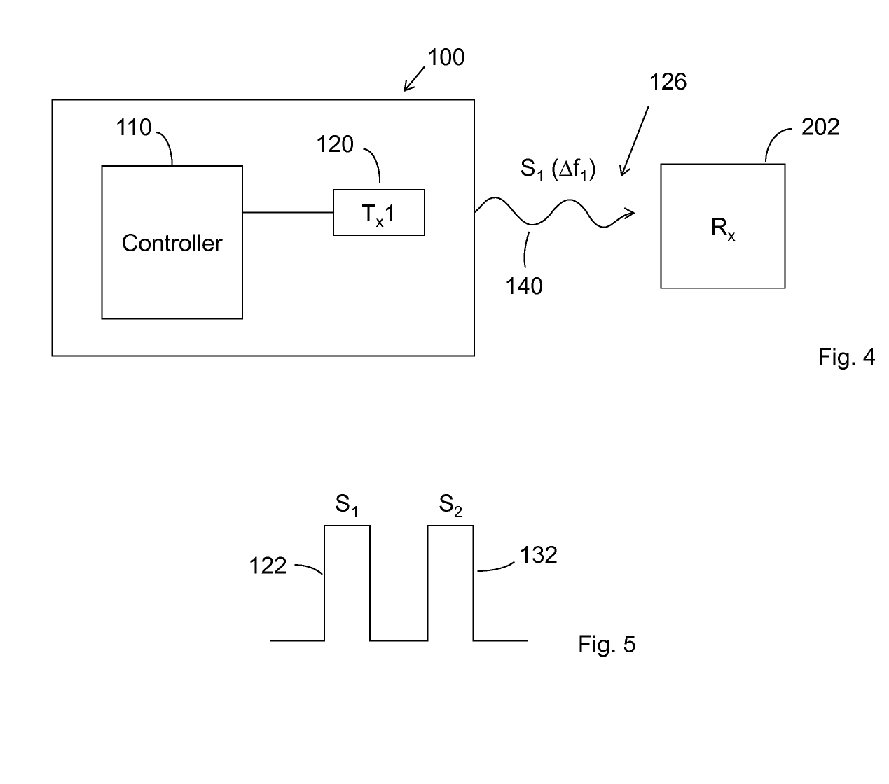

FIG. 4 shows schematically an example of an embodiment where the controller 110 controls the first transmitter 120 to perform power transfer 140 in the first channel 126 to a receiver device 202.

FIG. 5 shows schematically an example of an embodiment where a first signal S₁ 122 and a second signal S₂ 132 are transmitted sequentially.

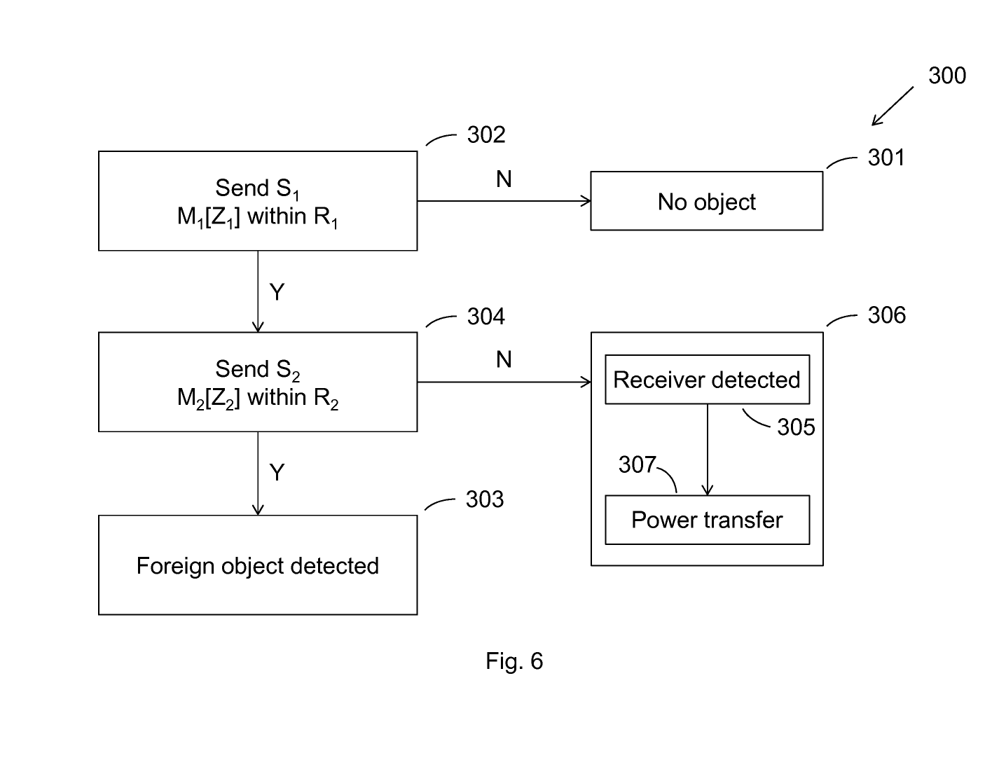

FIG. 6 shows schematically an example of an embodiment of the method 300 using the sequential first signals 122 and second signals 132 illustrated in FIG. 5.

At block 302, the first signal S₁ 122 is transmitted in the first channel 126 and a first measurement M[Z₁] that is dependent upon the first impedance Z₁ of the first channel 126 is performed. If the first measurement M[Z₁] that is dependent upon the first impedance Z₁ of the first channel is within a first range R₁ then the method moves to block 304. If it is not within the first range, the method moves to block 301.

At block 301, the method 300 determines that no object is in the charging area of the apparatus 100.

At block 304, the second signal S₂ 132 is transmitted and a second measurement M[Z₂] dependent upon the second impedance Z₂ of the second channel 136 is performed. If the second measurement M[Z₂] dependent upon the second impedance Z₂ of the second channel 136 is within a second range R₂ the method moves to block 303 and if it is not within the second range the method moves to block 306.

At block 303, the method 300 determines the presence of a foreign object. Power transfer does not occur or is disabled.

At block 306, the method 300 determines the detection of a receiver device 202 (sub-block 305) and enables power transfer via the first channel 126 to the receiver device 202 (sub-block 307).

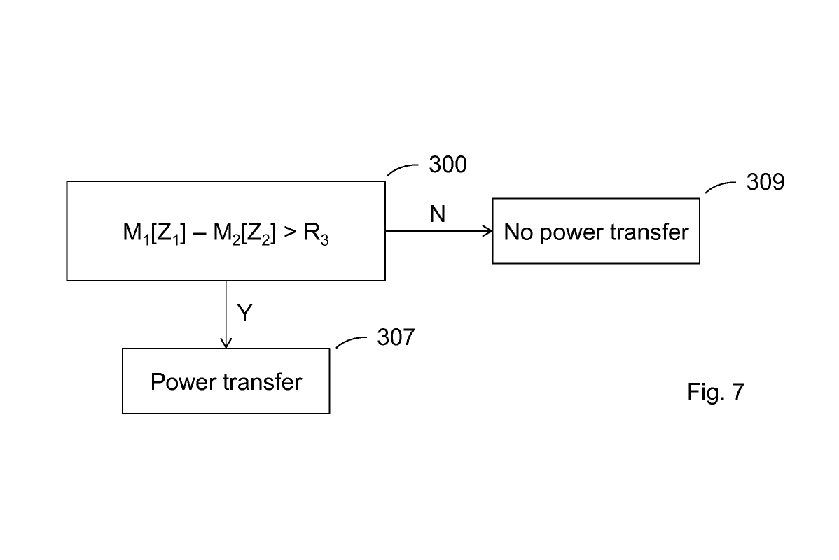

FIG. 7 shows schematically an example of an embodiment of an alternative method 300 which may be used when the first signal 122 and the second signal 132 are transmitted sequentially or in parallel. In this example, the difference between the first measurement M[Z₁] that is dependent upon the first impedance Z₁ of the first channel 126 and the second measurement M[Z₂] that is dependent upon the second impedance Z₂ of the second channel 136 is determined. If the difference between the first measurement and the second measurement is greater than a particular range R₃ then it is determined that a receiver device 202 is present and power transfer 307 via the first channel 126 is automatically enabled. However, if the difference between the first measurement M[Z₁] and the second measurement M[Z₂] is not greater than the range R₃ then it no power transfer occurs 309. There is no need to disambiguate between the circumstances where there is no object 200 and the situation where the object is a foreign object.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-rom or diskette, stored with data loadable in a memory of a computer system, the data representing the computer program. The data carrier may further be a data connection, such as a telephone cable or a wireless connection.

In the foregoing specification, the invention has been described with reference to specific examples of embodiments of the invention. It will, however, be evident that various modifications and changes may be made therein without departing from the broader spirit and scope of the invention as set forth in the appended claims and that the examples are merely illustrative.

For example, the connections may be a type of connection suitable to transfer signals from or to the respective nodes, units or devices, for example via intermediate devices. Accordingly, unless implied or stated otherwise the connections may for example be direct connections or indirect connections.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Although the invention has been described with respect to specific conductivity types or polarity of potentials, skilled artisans appreciated that conductivity types and polarities of potentials may be reversed.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different systems. For example, although FIG. 1 and the discussion thereof describe an exemplary architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Also for example, in one embodiment, the illustrated elements of system or apparatus 100 are circuitry located on a single integrated circuit or within a same device. Alternatively, system or apparatus 100 may include any number of separate integrated circuits or separate devices interconnected with each other.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of the software described herein may be received elements of system or apparatus 100, for example, from computer readable media such as memory or other media on other computer systems. Such computer readable media may be permanently, removably or remotely coupled to an information processing system such as system 100. The computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

Also, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while functionally operating as a single device.

Also, devices functionally forming separate devices may be integrated in a single physical device. However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class. The word ‘comprising’ does not exclude the presence of other elements or steps then those listed in a claim. Furthermore, the terms “a” or “an,” as used herein, are defined as one, or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

1. An apparatus for contactless charging a receiver device, comprising:
at least one transmitter for transferring energy through a non-radiative electromagnetic field to the receiver device in at least two channels,
a controller configured to control power transfer by said at least one transmitter via a first channel out of said at least two channels, defined by a first frequency band, in dependence upon:
a measurement, during transmission in the first channel, dependent upon an impedance of the first channel and
a measurement, during transmission in a second channel out of said at least two channels, defined by a second frequency band, dependent upon an impedance of the second channel.

2. An apparatus as claimed in claim 1, wherein said at least one transmitter comprises:
a first transmitter configured to transmit in a first channel defined by a first frequency band; and
a second transmitter configured to transmit in a second channel defined by a second frequency band.

3. An apparatus as claimed in claim 1, wherein the controller is configured to enable power transfer via the first channel when it is determined that there is a significant difference between the impedance of the first channel and the impedance of the second channel and wherein the controller is configured to disable power transfer via the first channel when it is determined that there is not a significant difference between the impedance of the first channel and the impedance of the second channel.

4. An apparatus as claimed in claim 1, wherein the controller is configured to control power transfer via the first channel in dependence upon the impedance of the first channel and the impedance of the second channel as a precursor to the initial transfer of power via the first channel.

5. An apparatus as claimed in claim 1, wherein the controller is configured to control power transfer via the first channel in dependence upon the impedance of the first channel and the impedance of the second channel intermittently during power transfer via the first channel.

6. An apparatus as claimed in claim 1, wherein the first channel and the second channel are distinct and separate channels wherein the first frequency band and the second frequency band do not overlap.

7. An apparatus as claimed in claim 1, wherein the first frequency band is less than 1 kHz and the second frequency band is greater than 100 kHz.

8. An apparatus as claimed in claim 1, wherein the controller is configured to control transmission of a first signal in the first channel to determine the measurement dependent upon the impedance of the first channel and wherein the controller is configured to control transmission of a second signal in the second channel to determine the measurement dependent upon the impedance of the second channel.

9. An apparatus as claimed in claim 8, wherein the controller is configured to control the first transmitter to send the first signal and then to determine whether the measurement dependent on the impedance of the first channel lies within a first range, and wherein if the measurement dependent upon the impedance of the first channel lies within the first range then the controller is configured to control the second transmitter to transmit the second signal and determine if the measurement dependent upon the impedance of the second channel is within a second range, and wherein if the measurement dependent upon the impedance of the second channel is within the second range then the controller is configured to enable power transfer via the first channel.

10. An apparatus as claimed in claim 9, wherein the controller is configured, if the measurement dependent upon the impedance of the first channel is outside the first range, to provide an indication to a user to reposition a receiver device to which power is to be transferred.

11. An apparatus as claimed in claim 9, wherein the controller is configured, if the measurement dependent on impedance of the second channel is outside the second range, to provide an indication to the user to remove a foreign object.

12. An apparatus as claimed in claim 1, configured as a contactless charger.

13. A method of contactless charging of a receiver device, comprising:
controlling transmission of energy through a non-radiative electromagnetic field to the receiver device in a first channel defined by a first frequency band to determine a measurement dependent upon impedance of the first channel;
controlling transmission of energy through a non-radiative electromagnetic field to the receiver device in a second channel defined by a second frequency band to determine a measurement dependent upon impedance of the second channel; and
controlling power transfer in the first channel in dependence upon the measurement dependent upon impedance of the first channel and the measurement dependent upon impedance of the second channel.

14. A method as claimed in claim 13, further comprising enabling power transfer via the first channel when there is a significant difference between the measurement dependent upon impedance of the first channel and the measurement dependent upon impedance of the second channel.

15. A method as claimed in claim 13, further comprising disabling power transfer via the first channel when there is not a significant difference between the measurement dependent upon impedance of the first channel and the measurement dependent upon impedance of the second channel.

16. A method as claimed in claim 13, wherein controlling power transfer via the first channel in dependence upon the measurement dependent upon impedance of the first channel and the measurement dependent upon impedance of the second channel is as a precursor to any power transfer via the first channel and wherein controlling power transfer in the first channel in dependence upon the measurement dependent upon the impedance of the first channel and the measurement dependent upon impedance of the second channel occurs intermittently during power transfer via the first channel.

17. (canceled)

18. (canceled)

19. (canceled)

20. A method as claimed in claim 13, comprising controlling transmission of a first signal of short duration in the first channel to determine the measurement dependent upon impedance of the first channel and transmitting a second signal of short duration in the second channel to determine the measurement dependent on impedance of the second channel.

21. A method as claimed in claim 20, comprising transmission of the first signal in the first channel, then, if the measurement dependent upon the impedance of the first channel is within a first range, transmitting the second signal in the second channel, then, if the measurement dependent on the impedance of the second channel is within a second range, enabling power transfer via the first channel.

22. A method as claimed in claim 21, wherein if the measurement dependent upon the impedance of the first channel is outside the first range, providing an indication to a user to reposition a receiver device to which power is to be transferred and wherein when the measurement dependent upon the impedance of the second channel is outside the second range, providing an indication to the user to remove a foreign object.

23. (canceled)

24. (canceled)

25. (canceled)

26. (canceled)

27. An apparatus comprising:
a first transmitter configured to transmit in a first channel defined by a first frequency band;
a second transmitter configured to transmit in a second channel defined by a second frequency band; and
a controller configured to control power transfer via the first channel in dependence upon an impedance of the first channel and an impedance of the second channel.
